(19) United States
(12) Patent Application Publication
(10) Pub. No.: US 2024/0144086 A1
(43) Pub. Date: May 2, 2024

(54) METHOD AND APPARATUS WITH MACHINE LEARNING

(71) Applicant: SAMSUNG ELECTRONICS CO., LTD., Suwon-si (KR)

(72) Inventors: Chanho AHN, Suwon-si (KR); Kikyung KIM, Suwon-si (KR); Jiwon BAEK, Suwon-si (KR); Seungju HAN, Suwon-si (KR)

(73) Assignee: SAMSUNG ELECTRONICS CO., LTD., Suwon-si (KR)

(21) Appl. No.: 18/314,378

(22) Filed: May 9, 2023

(30) Foreign Application Priority Data
Nov. 2, 2022 (KR) 10-2022-0144133
Dec. 30, 2022 (KR) 10-2022-0190455

(51) Int. Cl. G06N 20/00

(52) U.S. Cl. CPC G06N 20/00

(57) ABSTRACT

A processor-implemented method includes: determining a prediction loss based on class prediction data obtained by applying a first machine learning model to a training input and a class label with which the training input is labeled; determining a confidence of the class label based on the determined prediction loss; and training a second machine learning model using the training input based on the determined confidence.

### CROSS-REFERENCE TO RELATED APPLICATIONS

This application claims the benefit under 35 USC § 119(a) of Korean Patent Application No. 10-2022-0144133, filed on Nov. 2, 2022, and Korean Patent Application No. 10-2022-0190455, filed on Dec. 30, 2022, in the Korean Intellectual Property Office, the entire disclosures of which are incorporated herein by reference for all purposes.

### BACKGROUND

### 1 Field

The following description relates to a method and apparatus with machine learning.

### 2. Description of Related Art

A model trained with a loss function based on a symmetric loss function on a training dataset including label noise may be a model of which a loss value is minimized in data without noise.

When a loss function based on a symmetric loss function is used, a machine learning model optimally trained on data without label noise and a model optimally trained on data including label noise may be the same. A stochastic gradient descent scheme, which may be used to process a large amount of data, may not guarantee that an optimal model will be found. Moreover, a symmetry loss function may be more difficult than a cross-entropy loss that is used to solve a classification problem to find an optimal model.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one or more general aspects, a processor-implemented method includes: determining a prediction loss based on class prediction data obtained by applying a first machine learning model to a training input and a class label with which the training input is labeled; determining a confidence of the class label based on the determined prediction loss; and training a second machine learning model using the training input based on the determined confidence.

The first machine learning model may be trained using a symmetric loss function used to determine a sum of values of the symmetric loss function as a constant, in which the values are determined in response to a prediction that a training input is classified as each of a plurality of classes.

The determining of the confidence may include determining a confidence that represents a probability that the class label is identical to a real class of the training input.

The determining of the confidence may include: determining the confidence based on a reference loss determined based on another training input and the determined prediction loss; and updating the reference loss based on the determined prediction loss.

The determining of the prediction loss may include: determining a first prediction loss based on first class prediction data obtained by applying the first machine learning model and the class label; and determining a second prediction loss based on second class prediction data obtained by applying the second machine learning model to the training input and the class label, and the determining of the confidence may include determining the confidence based on the determined first prediction loss and the determined second prediction loss.

The training of the second machine learning model may include updating a parameter of the second machine learning model using second class prediction data obtained by applying the second machine learning model to the training input, the class label, and a loss function of the second machine learning model determined based on the determined confidence.

The training of the second machine learning model further may include updating a parameter of the second machine learning model using a loss function of the second machine learning model from which a symmetric loss function is excluded.

The method may include updating a parameter of the first machine learning model using a loss function of the first machine learning model determined based on a difference between parameters of the first machine learning model and the second machine learning model.

The training of the second machine learning model may include: relabeling the training input with a class label based on the determined confidence being less than or equal to a threshold confidence; and training the second machine learning model based on the training input and the class label with which the training input is relabeled.

The relabeling of the training input with the class label may include relabeling the training input with the class label based on a user input for relabeling the training input.

The relabeling of the training input with the class label may include: determining a threshold confidence based on a number of times the training input is relabeled; and relabeling the training input with the class label in response to the determined confidence being less than or equal to the determined threshold confidence.

The relabeling of the training input with the class label may include relabeling the training input based on the class prediction data obtained using the first machine learning model.

In one or more general aspects, a non-transitory computer-readable storage medium stores instructions that, when executed by a processor, configure the processor to perform any one, any combination, or all of operations and/or methods described herein.

In one or more general aspects, an electronic apparatus includes: one or more processors configured to: determine a prediction loss based on class prediction data obtained by applying a first machine learning model to a training input and a class label with which the training input is labeled; determine a confidence of the class label based on the determined prediction loss; and train a second machine learning model using the training input based on the determined confidence.

The first machine learning model may be trained using a symmetric loss function used to determine a sum of values of the symmetric loss function as a constant, in which the values are determined in response to prediction that a training input is classified as each of a plurality of classes.

For the determining of the confidence, the one or more processors may be configured to determine a confidence that represents a probability that the class label is identical to a real class of the training input.

For the determining of the confidence, the one or more processors may be configured to: determine the confidence based on a reference loss determined based on another training input and the determined prediction loss; and update the reference loss based on the determined prediction loss.

The one or more processors may be configured to: for the determining of the prediction loss, determine a first prediction loss based on first class prediction data obtained by applying the first machine learning model and the class label; and determine a second prediction loss based on second class prediction data obtained by applying the second machine learning model to the training input and the class label; and for the determining of the confidence, determine the confidence based on the determined first prediction loss and the determined second prediction loss.

The one or more processors may be configured to update a parameter of the second machine learning model using a loss function of the second machine learning model from which a symmetric loss function is excluded.

The one or more processors may be configured to: relabel the training input with a class label based on the determined confidence being less than or equal to a threshold confidence; and train the second machine learning model based on the training input and the class label with which the training input is relabeled.

In one or more general aspects, a processor-implemented method includes: determining class prediction data by applying a trained second machine learning model to input data; and classifying the input data based on the determined class prediction data, wherein the second machine learning model is trained by determining a prediction loss based on training class prediction data obtained by applying a first machine learning model to a training input and a class label with which the training input is labeled.

Other features and aspects will be apparent from the following detailed description, the drawings, and the claims.

### BRIEF DESCRIPTION OF THE DRAWINGS

FIG. 1 illustrates an example of an electronic apparatus.

FIG. 2A illustrates an example of a configuration of an electronic apparatus that uses a second machine learning model.

FIG. 2B illustrates an example of an operation of determining a subsequent operation using a second machine learning model.

FIG. 3 illustrates an example of a method of training a machine learning model.

FIG. 4 illustrates an example of confidence calculation based on a reference loss and a prediction loss.

FIG. 5 illustrates an example of confidence calculation based on a first prediction loss and a second prediction loss.

FIG. 6 illustrates an example of an operation of relabeling a training input with a class label.

Throughout the drawings and the detailed description, unless otherwise described or provided, it shall be understood that the same drawing reference numerals refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after an understanding of the disclosure of this application may be omitted for increased clarity and conciseness.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Throughout the specification, when a component or element is described as being “on”, “connected to,” “coupled to,” or “joined to” another component, element, or layer it may be directly (e.g., in contact with the other component or element) “on”, “connected to,” “coupled to,” or “joined to” the other component, element, or layer or there may reasonably be one or more other components, elements, layers intervening therebetween. When a component or element is described as being “directly on”, “directly connected to,” “directly coupled to,” or “directly joined” to another component or element, there can be no other elements intervening therebetween. Likewise, expressions, for example, “between” and “immediately between” and “adjacent to” and “immediately adjacent to” may also be construed as described in the foregoing.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof.

As used herein, the term “and/or” includes any one and any combination of any two or more of the associated listed items. The phrases “at least one of A, B, and C”, “at least one of A, B, or C”, and the like are intended to have disjunctive meanings, and these phrases “at least one of A, B, and C”, “at least one of A, B, or C”, and the like also include examples where there may be one or more of each of A, B, and/or C (e.g., any combination of one or more of each of A, B, and C), unless the corresponding description and embodiment necessitates such listings (e.g., “at least one of A, B, and C”) to be interpreted to have a conjunctive meaning.

Unless otherwise defined, all terms, including technical or scientific terms, used herein have the same meaning as is commonly understood by one of ordinary skill in the art to which this disclosure pertains and based on an understanding of the disclosure of the present application. Terms, such as those defined in commonly used dictionaries, are to be construed to have meanings matching with contextual meanings in the relevant art and the disclosure of the present application, and are not to be construed to have an ideal or excessively formal meaning unless otherwise defined herein.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application. The use of the term “may” herein with respect to an example or embodiment, e.g., as to what an example or embodiment may include or implement, means that at least one example or embodiment exists where such a feature is included or implemented, while all examples are not limited thereto.

Hereinafter, examples will be described in detail with reference to the accompanying drawings. In the descriptions of the examples referring to the accompanying drawings, like reference numerals refer to like elements and any repeated description related thereto will be omitted.

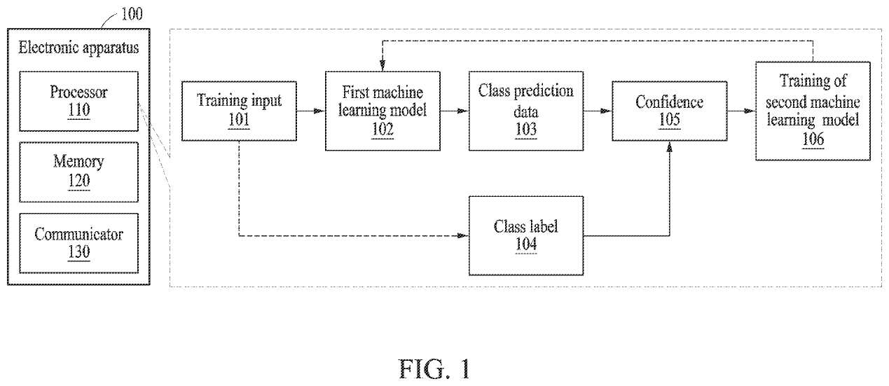

FIG. 1 illustrates an example of an electronic apparatus.

An electronic apparatus 100 may train a second machine learning model using a first machine learning model 102. For example, for use in training 106 of the second machine learning model, the electronic apparatus 100 may calculate (e.g., determine) a confidence 105 of a class label 104 with which a training input 101 is labeled using the first machine learning model 102. The electronic apparatus 100 may perform the training 106 of the second machine learning model based on the training input 101 using the calculated confidence 105.

The first machine learning model 102 may be or include a machine learning model that outputs class prediction data 103 (e.g., first class prediction data) for a plurality of classes when applied to input data (e.g., the training input 101). The input data may include data including information about a target of classification. The class prediction data 103 may include data representing a possibility (e.g., a probability) that the input data (or the target of classification) belongs to the plurality of classes. For example, the class prediction data 103 may include a plurality of possibility scores corresponding to the plurality of classes. Each of the possibility scores may represent a possibility that the input data belongs to a class corresponding to a corresponding possibility score. The class prediction data 103 may indicate that a class having a maximum possibility score among the plurality of possibility scores is a class of the input data.

For example, the input data may include an input image obtained for a semiconductor device (e.g., a wafer). For example, the input image may include an image captured for a wafer on which a predetermined semiconductor process is performed. A semiconductor process may include, for example, any one or any combination of any two or more of a wafer fabrication process, an oxidation process, a photo process, an etching process, a deposition process, a metallization process, an electrical test process, and a packaging process. However, the semiconductor process is not limited to the above-described examples, and may include at least a partial process of the wafer fabrication process, the oxidation process, the photo process, the etching process, the deposition process, the metallization process, the electrical test process, or the packaging process.

For example, the class prediction data 103 may represent a possibility that the input image (or the semiconductor device) belongs to each of the plurality of classes. The plurality of classes may include a normal class and a defective class. However, the normal class and the defective class are not limited to being a single class. For example, the plurality of classes may include a plurality of defective classes based on a type of defect of the semiconductor device. For example, the plurality of classes may include any one or any combination of any two or more of a first defective class corresponding to a defect related to particles of the semiconductor device, a second defective class corresponding to a defect related to electrical wiring of the semiconductor device, a third defective class corresponding to a defect related to a bumped ball of the semiconductor device, and a fourth defective class corresponding to a defect related to a cracked ball of the semiconductor device.

The first machine learning model 102 may be or include a machine learning model trained to be robust to label noise of a training dataset. The training dataset (e.g., a first training dataset) of the first machine learning model may include a plurality of training pairs. Each of the training pairs may include a training input (e.g., the training input 101) and a class label (e.g., the class label 104) with which the training input is labeled. The label noise may include an error in the class label, and, for example, the label noise may include the class label when the class label is a class different from a real (e.g., actual or more accurate) class of the training input.

Herein, “a machine learning model robust to label noise” may be a machine learning model that outputs class prediction data (e.g., class prediction data 103) that indicates the real class of the training input 101 instead of the class label 104 with which the training input 101 is labeled, which includes label noise, when this machine learning model is trained to be robust to the label noise and applied to the training input 101. For example, when the class label 104 with which the training input 101 is labeled includes label noise (e.g., when the class label is different from the real class of the training input 101), the class prediction data 103 may include a first possibility score corresponding to the class label 104 and a second possibility score corresponding to the real class, and the second possibility score may have a greater value than the first possibility score.

For example, the first machine learning model 102 may be trained using a symmetric loss function. The symmetric loss function may be a loss function that calculates a sum of values of a loss function as a constant, in which the values of the loss function are calculated when it is predicted that the training input is classified as each of the classes. For example, the symmetric loss function (L) may satisfy Equation 1 below, for example.

Σ_{c∈C}L(·,c)=Const. Equation 1:

Here, L may denote a symmetric loss function, C may denote a class set including a plurality of classes, c may denote each class included in the class set, may denote an arbitrary training input (or class prediction data for a training input), and Const. may denote a constant.

For example, the first machine learning model 102 may be trained using a loss function disclosed in any one or any combination of any two or more of the theses “Robust Loss Functions under Label Noise for Deep Neural Networks (AAAI, 2017),” “Generalized Cross Entropy Loss for Training Deep Neural Networks with Noisy Labels (NeurIPS, 2018),” and “Generalized Jensen-Shannon Divergence Loss for Learning with Noisy Labels (NeurIPS, 2021).”

The first training dataset used to train the first machine learning model 102 may be independent of a second training dataset used to train 106 the second machine learning model. For example, the first machine learning model 102 may be trained using the first training dataset different from the second training dataset. For example, the first machine learning model 102 may be trained using at least a portion of the second training dataset.

The second machine learning model may output class prediction data (e.g., second class prediction data) when applied to the input data. The second machine learning model may be or include a model trained using the first machine learning model 102. The electronic apparatus 100 may train the second machine learning model based on a training dataset (e.g., the second training dataset) of the second machine learning model. The training dataset of the second machine learning model may include a plurality of training pairs, and each of the training pairs may include the training input 101 and the class label 104 with which the corresponding input is labeled.

For example, the electronic apparatus 100 may obtain (e.g., determined) the class prediction data 103 (e.g., the first class prediction data) by applying the first machine learning model 102 to the training input 101. The electronic apparatus 100 may calculate the confidence 105 of the class label 104 based on the class prediction data 103 and the class label 104. The confidence 105 may represent a possibility that the class label 104 is identical to the real class of the training input 101. The electronic apparatus 100 may perform the training 106 of the second machine learning model based on the training input 101, based on the calculated confidence 105. In addition to the electronic apparatus 100 training the second machine learning model based on the first machine learning model 102, the electronic apparatus 100 may train the first machine learning model 102 based on the second machine learning model.

The electronic apparatus 100 may include a processor 110 (e.g., one or more processors), a memory 120 (e.g., one or more memories), and a communicator 130.

The processor 110 may obtain the class prediction data 103 by applying the first machine learning model 102 to the training input 101, calculate the confidence 105 based on the class prediction data 103 and the class label 104, and perform the training 106 of the second machine learning model based on the calculated confidence 105.

The memory 120 may temporarily and/or permanently store any one or any combination of any two or more of the training input 101, the first machine learning model 102, the class prediction data 103, the class label 104, the confidence 105, and the second machine learning model. The memory 120 may store instructions to obtain the class prediction data 103, instructions to calculate the confidence 105, and/or instructions to perform the training 106 of the second machine learning model. For example, the memory 120 may include a non-transitory computer-readable storage medium storing instructions that, when executed by the processor 110, configure the processor 110 to perform any one or any combination of any two or more of the methods and operations described herein with respect to FIGS. 1-6. However, these are merely examples, and the information stored in the memory 120 is not limited thereto.

The communicator 130 may transmit and receive any one or any combination of any two or more of (or information about any one or any combination of any two or more of) the training input 101, the first machine learning model 102, the class prediction data 103, the class label 104, the confidence 105, and the second machine learning model. The communicator 130 may establish a wired communication channel and/or a wireless communication channel with an external apparatus (e.g., another electronic apparatus and a server), and may establish communication via a long-range communication network, such as cellular communication, short-range wireless communication, local area network (LAN) communication, Bluetooth™, wireless-fidelity (Wi-Fi) direct or infrared data association (IrDA), a legacy cellular network, a fourth generation (4G) and/or 5G network, next-generation communication, the internet, and/or a computer network (e.g., LAN or a wide area network (WAN)).

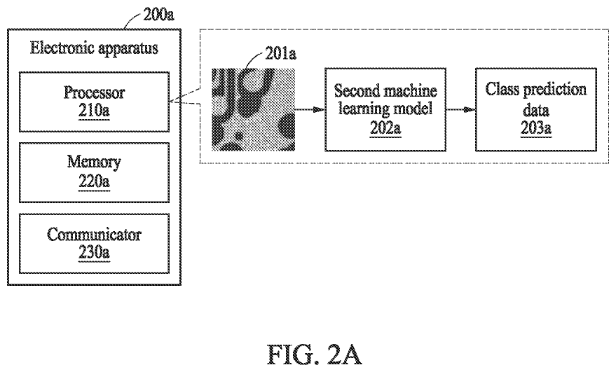

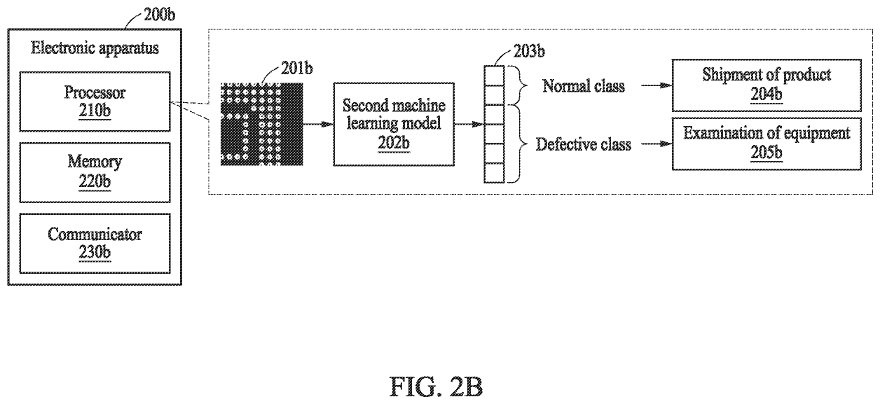

FIG. 2A illustrates an example of a configuration of an electronic apparatus that uses a second machine learning model.

An electronic apparatus 200a may determine a class of input data 201a based on a trained second machine learning model 202a. The electronic apparatus 200a may be implemented as an electronic apparatus different from a training apparatus (e.g., the electronic apparatus 100) that trains the second machine learning model. However, the electronic apparatus 200a is not limited to being implemented as the electronic apparatus different from the training apparatus, and the electronic apparatus 200a may be implemented integrally with the training apparatus. As a non-limiting example, the electronic apparatus 200a may be or include the electronic apparatus 100, the processor 210a may be or include the processor 110, the memory 220a may be or include a memory 120, and the communicator 230a may be or include a communicator 130.

The electronic apparatus 200a may obtain class prediction data 203a by applying the second machine learning model 202a to the input data 201a. The second machine learning model 202a may be or include a model trained using a first machine learning model (e.g., the first machine learning model 102 of FIG. 1). The first machine learning model may be or include a model trained to be robust to label noise of a training dataset, and may be or include, for example, a model trained using a symmetric loss function.

The electronic apparatus 200a may classify the input data 201a (or a target of classification) based on the class prediction data 203a. The electronic apparatus 200a may determine a class to which the input data 201a (or the target of classification) belongs based on the class prediction data 203a. The electronic apparatus 200a may determine that a class indicated by the class prediction data 203a is a class of the input data 201a. For example, the electronic apparatus 200a may determine that a class having a maximum possibility score among a plurality of possibility scores of the class prediction data 203a is the class of the input data 201a.

As illustrated in FIG. 2A, the input data 201a may include an input image of a semiconductor device. For example, the input data 201a may include an input image of a wafer at a semiconductor packaging level. The class prediction data 203a may include a possibility score representing a possibility that the wafer (or the input image) at the packaging level belongs to a corresponding class for each of a plurality of classes. The plurality of classes may include at least one normal class and at least one defective class.

The electronic apparatus 200a may include a processor 210a (e.g., one or more processors), a memory 220a (e.g., one or more memories), and a communicator 230a.

The processor 210a may obtain the class prediction data 203a by applying the second machine learning model 202a to the input data 201a and determine a class of the input data 201a based on the class prediction data 203a.

The memory 220a may temporarily and/or permanently store any one or any combination of any two or more of the input data 201a, the second machine learning model 202a, and the class prediction data 203a. The memory 220a may store instructions to obtain the class prediction data 203a and/or instructions to determine the class of the input data 201a. For example, the memory 220a may include a non-transitory computer-readable storage medium storing instructions that, when executed by the processor 210a, configure the processor 210a to perform any one or any combination of any two or more of the methods and operations described herein with respect to FIGS. 1-6. However, these are merely examples, and the information stored in the memory 220a is not limited thereto.

The communicator 230a may transmit and receive any one or any combination of any two or more of (or information about any one or any combination of any two or more of) the input data 201a, the second machine learning model 202a, and the class prediction data 203a. The communicator 130 may establish a wired communication channel and/or a wireless communication channel with an external apparatus (e.g., another electronic apparatus and a server), and may establish communication via a long-range communication network, such as cellular communication, short-range wireless communication, local area network (LAN) communication, Bluetooth™, wireless-fidelity (Wi-Fi) direct or infrared data association (IrDA), a legacy cellular network, a fourth generation (4G) and/or 5G network, next-generation communication, the internet, and/or a computer network (e.g., LAN or a wide area network (WAN)).

FIG. 2B illustrates an example of an operation of determining a subsequent operation using a second machine learning model.

An electronic apparatus 200b may determine a class of input data 201b based on a trained second machine learning model 202b. The electronic apparatus 200b may be implemented as an electronic apparatus different from a training apparatus (e.g., the electronic apparatus 100) that trains the second machine learning model. However, the electronic apparatus 200b is not limited to being implemented as the electronic apparatus different from the training apparatus, and the electronic apparatus 200b may be implemented integrally with the training apparatus. As a non-limiting example, the electronic apparatus 200b may be or include the electronic apparatus 100, the processor 210b may be or include the processor 110, the memory 220b may be or include a memory 120, and the communicator 230b may be or include a communicator 130.

The electronic apparatus 200b may obtain class prediction data 203b by applying the second machine learning model 202b to the input data 201b. The second machine learning model 202b may be or include a model trained using a first machine learning model (e.g., the first machine learning model 102 of FIG. 1). For example, the second machine learning model 202b may be, or may be obtained by copying, the second machine learning model obtained by the training apparatus (e.g., the electronic apparatus 100 of FIG. 1) that trains the second machine learning model using the first machine learning model. The first machine learning model may be or include a model trained to be robust to label noise of a training dataset, and may include, for example, a model trained using a symmetric loss function.

As illustrated in FIG. 2B, the input data 201b may include, for example, the input image of the semiconductor device. The input data 201b may include an input image (e.g., L6 data) of the wafer at a semiconductor package test level. The class prediction data 203b may include a plurality of possibility scores corresponding to the plurality of classes. The class prediction data 203b may include possibility scores representing possibilities that the wafer (or the input image) at the semiconductor package test level belongs to a corresponding class for each of a plurality of normal classes (e.g., two normal classes) and a plurality of defective classes (e.g., four defective classes).

The electronic apparatus 200b may classify the input data 201b (or a target of classification) based on the class prediction data 203b. The electronic apparatus 200b may determine a class to which the input data 201b (or the target of classification) belongs based on the class prediction data 203b. The electronic apparatus 200b may determine that a class indicated by the class prediction data 203b is a class of the input data 201b. The electronic apparatus 200b may determine that a class having a maximum possibility score among a plurality of possibility scores of the class prediction data 203b is the class of the input data 201b.

The electronic apparatus 200b may determine a subsequent operation based on a classification result. The electronic apparatus 200b may determine the subsequent operation based on the determined class. For example, the electronic apparatus 200b may determine that an operation mapped to the determined class is the subsequent operation. As illustrated in FIG. 2B, for example, the plurality of classes may include the two normal classes and four defective classes. The electronic apparatus 200b may determine that shipment of a product 204b is the subsequent operation based on the determined class being one of the normal classes. The electronic apparatus 200b may determine that an examination of equipment 205b is the subsequent operation based on the determined class being one of the defective classes.

The electronic apparatus 200b may include a processor 210b (e.g., one or more processors), a memory 220b (e.g., one or more memories), and a communicator 230b.

The processor 210b may obtain the class prediction data 203b by applying the second machine learning model 202b to the input data 201b, determine the class of the input data 201b based on the class prediction data 203b, and determine the subsequent operation based on the determined class.

The memory 220b may temporarily and/or permanently store any one or any combination of any two or more of the input data 201b, the second machine learning model 202b, the class prediction data 203b, and the subsequent operation (e.g., the shipment of a product 204b or the examination of equipment 205b). The memory 220b may store instructions to obtain the class prediction data 203b, instructions to determine the class of the input data 201b, and/or instructions to determine the subsequent operation. For example, the memory 220b may include a non-transitory computer-readable storage medium storing instructions that, when executed by the processor 210b, configure the processor 210b to perform any one or any combination of any two or more of the methods and operations described herein with respect to FIGS. 1-6. However, these are merely examples, and the information stored in the memory 220b is not limited thereto.

The communicator 230b may transmit and receive any one or any combination of any two or more of (or information about any one or any combination of any two or more of) the input data 201b, the second machine learning model 202b, the class prediction data 203b, and the subsequent operation (e.g., the shipment of a product 204b or the examination of equipment 205b). The communicator 130 may establish a wired communication channel and/or a wireless communication channel with an external apparatus (e.g., another electronic apparatus and a server), and may establish communication via a long-range communication network, such as cellular communication, short-range wireless communication, local area network (LAN) communication, Bluetooth™, wireless-fidelity (Wi-Fi) direct or infrared data association (IrDA), a legacy cellular network, a fourth generation (4G) and/or 5G network, next-generation communication, the internet, and/or a computer network (e.g., LAN or a wide area network (WAN)).

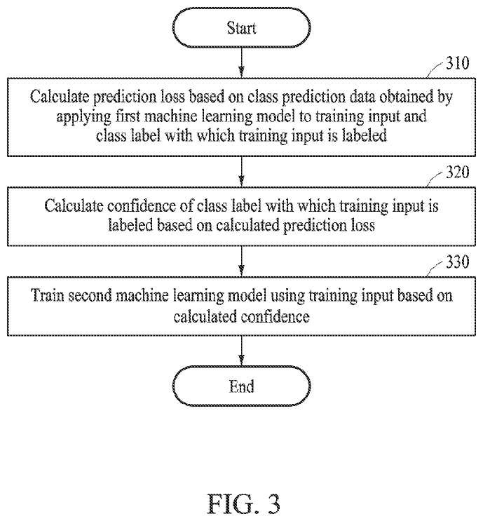

FIG. 3 illustrates an example of a method of training a machine learning model.

An electronic apparatus (e.g., the electronic apparatus 100 of FIG. 1) may train a second machine learning model using a first machine learning model. The electronic apparatus may evaluate a training input included in a training dataset of the second machine learning model and/or a class label with which the training input is labeled. When training the second machine learning model based on the training input and/or the class label with which the training input is labeled, the electronic apparatus may use a result of evaluating the training input and/or the class label with which the training input is labeled.

In operation 310, the electronic apparatus may calculate a prediction loss based on class prediction data obtained by applying the first machine learning model to the training input and the class label with which the training input is labeled.

The electronic apparatus may obtain the class prediction data (e.g., first class prediction data) by applying the first machine learning model (e.g., the first machine learning model 102 of FIG. 1) to the training input.

The class prediction data may include data representing a possibility that the training input belongs to a plurality of classes. For example, the class prediction data may include a plurality of possibility scores corresponding to the plurality of classes. Each of the possibility scores may represent a possibility that the training input belongs to a class corresponding to a corresponding possibility score. The class prediction data may indicate that a class having a maximum possibility score among the plurality of possibility scores is a class of the training input.

The first machine learning model may be or include a machine learning model trained to be robust to label noise of a training dataset. For example, the first machine learning model may be or include a machine learning model trained using a symmetric loss function. As described above with reference to FIG. 1, the symmetric loss function may be a loss function that calculates a sum of values of a loss function as a constant, in which the values of the loss function are calculated when it is predicted that the training input is classified as each of the classes.

The class prediction data based on the first machine learning model may indicate a real class of the training input. For example, even when the class label with which the training input is labeled differs from the real class of the training input, the first machine learning model may be applied to the training input, and thus, the class prediction data indicating the real class of the training input may be obtained.

The electronic apparatus may calculate the prediction loss based on the class prediction data and the class label. The prediction loss may represent a difference between a result (e.g., the class prediction data) of predicting a class of the training input obtained using the machine learning model and the class label with which the training input is labeled.

For example, when a first class predicted as the class of the training input using the machine learning model is identical to a second class with which the training input is labeled, the calculated prediction loss may be less than a prediction loss calculated when the first class differs from the second class. The first class may be a class having a maximum possibility score among a plurality of possibility scores of the class prediction data.

For example, when the prediction result obtained using the machine learning model indicates the class label, the prediction loss may calculate a loss function based on a possibility score for the class label. As the possibility score of the class prediction data for the class label increases, a value of the calculated prediction loss may decrease. A value of the prediction loss calculated based on class prediction data having a second possibility score less than a first possibility score for the class label may be less than a value of the prediction loss calculated based on class prediction data having the first possibility score.

For example, the electronic apparatus may calculate the prediction loss based on any one or any combination of any two or more of mean squared error (MSE), root mean squared error (RMSE), and cross-entropy.

In operation 320, the electronic apparatus may calculate a confidence of the class label with which the training input is labeled based on the calculated prediction loss. The confidence may represent a possibility that the class label with which the training input is labeled is identical to the real class of the training input. For example, when a first confidence of a first class label of a first training input is greater than a second confidence of a second class label of a second training input, a possibility that the second class label is identical to a real class of the second training input may be higher than a possibility that the first class label is identical to a real class of the first training input.

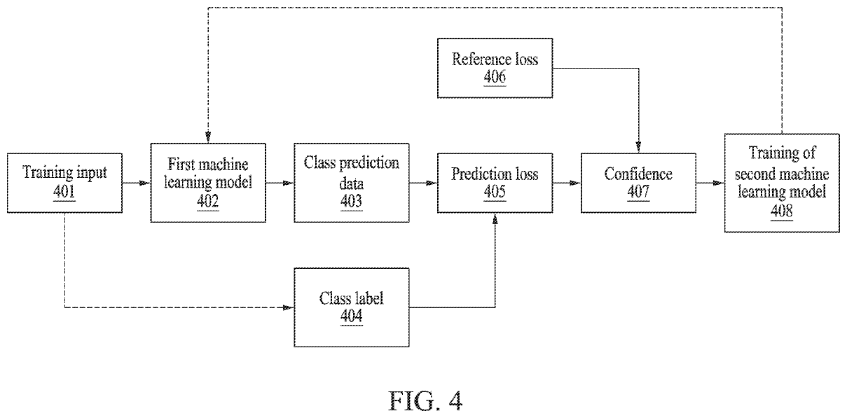

The electronic apparatus may calculate the confidence based on a reference loss and a prediction loss. The reference loss may be or include a loss determined based on another training input. A non-limiting example of confidence calculation based on the reference loss and the prediction loss will be described in detail with reference to FIG. 4.

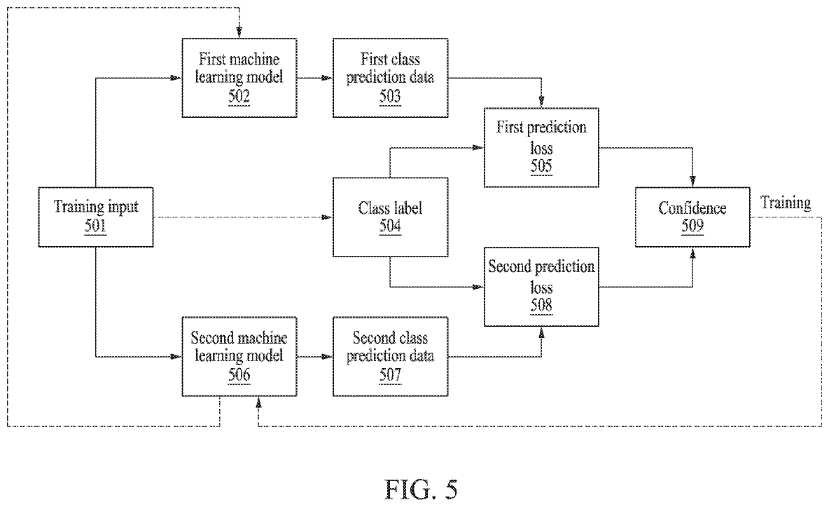

The electronic apparatus may calculate a first prediction loss based on the first machine learning model and a second prediction loss based on the second machine learning model and calculate the confidence based on the calculated first prediction loss and the calculated second prediction loss. A non-limiting example of confidence calculation based on the first prediction loss and the second prediction loss will be described in detail with reference to FIG. 5.

In operation 330, the electronic apparatus may train the second machine learning model based on the calculated confidence. The electronic apparatus may train the second machine learning model by calculating a loss function of the second machine learning model and updating a parameter of the second machine learning model based on the calculated loss function. Accordingly, by training the second machine learning model using the first machine learning model that is robust to label noise, the electronic apparatus of one or more embodiments may train the second machine learning model more accurately than a typical electronic apparatus that trains a machine learning model based on a training input with an inaccurate or erroneous class label without using a machine learning model robust to label noise.

The electronic apparatus may update the parameter of the second machine learning model using the loss function of the second machine learning model calculated based on the second class prediction data, the class label, and the calculated confidence. The second class prediction data may include class prediction data obtained by applying the second machine learning model to the training input. The electronic apparatus may calculate the loss function of the second machine learning model by applying a weight based on the calculated confidence to a difference between the second class prediction data and the class label. The difference between the second class prediction data and the class label may include a loss value (e.g., MSE, RMSE, and cross-entropy) based on the second class prediction data and the class label. When the second confidence of the second class label of the second training input is greater than the first confidence of the first class label of the first training input, the electronic apparatus may apply a greater weight to the second training input than to the first training input in calculating the loss function of the second machine learning model. For example, the electronic apparatus may calculate the loss function of the second machine learning model by multiplying the confidence by the loss function representing the difference between the second class prediction data and the class label. For example, the loss function of the second machine learning model may be calculated based on Equation 2 below, for example.

$${\sum }_{( w , x , y ) ∈ D} w \times L ( f ( x ; θ ) , y ) \qquad Equation 2$$

Here, x may denote the training input, y may denote the class label with which the training input (x) is labeled, w may denote the confidence of the class label (y), D may denote the training dataset of the second machine learning model, L may denote a cross-entropy function, f may denote the second machine learning model, θ may denote the parameter of the second machine learning model (f).

The electronic apparatus may update the parameter of the second machine learning model using the loss function of the second machine learning model from which the symmetric loss function is excluded. The electronic apparatus may exclude the symmetric loss function from the loss function of the second machine learning model.

The electronic apparatus of one or more embodiments may benefit from the symmetric loss function by training the second machine learning model using the first machine learning model trained using the symmetric loss function and minimize disadvantages of the symmetric loss function by excluding the symmetric loss function from the loss function of the second machine learning model. The symmetric loss function may have an advantage of being used to train a machine learning model such that the machine learning model is robust to label noise and also have a disadvantage in terms of training efficiency and/or performance of a trained machine learning model. The training efficiency may be determined, for example, based on a number of epochs required for training. The electronic apparatus of one or more embodiments may reduce an impact the label noise has on training of the second machine learning model by training the second machine learning model using a confidence determined based on the first machine learning model robust to the label noise, and the electronic apparatus of one or more embodiments may reduce training efficiency degradation and/or performance degradation of the second machine learning model caused by the symmetric loss function by training the second machine learning model using the loss function of the second machine learning model from which the symmetric loss function is excluded.

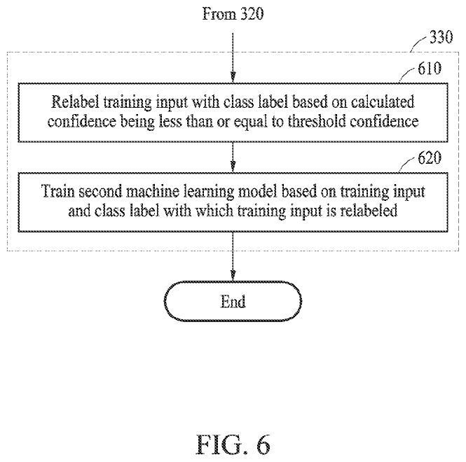

The electronic apparatus may relabel the training input with a class label based on a result of comparing a threshold confidence and a calculated confidence. When the class label with which the training input is labeled has a confidence less than or equal to the threshold confidence, the class label may be changed through relabeling. Relabeling is not limited to changing the class label, and the training input may be relabeled with the existing class label such that the class label may remain the same. The electronic apparatus may relabel the training input with a class determined based on the class prediction data obtained based on the first machine learning model and/or a user input. A non-limiting example of the relabeling of a training input with a class will be described in detail later with reference to FIG. 6.

Additionally, in operation 330, the electronic apparatus may train the first machine learning model based on the second machine learning model. The electronic apparatus may improve training efficiency and/or performance of the first machine learning model by training the first machine learning model using knowledge of the second machine learning model. For example, the electronic apparatus may train the first machine learning model by calculating a loss function of the first machine learning model based on the second machine learning model and updating a parameter of the first machine learning model based on the calculated loss function.

The electronic apparatus may calculate the loss function of the first machine learning model based on a difference between parameters of the first machine learning model and the second machine learning model. The electronic apparatus may update the parameter of the first machine learning model using the loss function of the first machine learning model. For example, the electronic apparatus may calculate the difference between the parameters of the first machine learning model and the second machine learning model as a Euclidean distance. The electronic apparatus may train the first machine learning model using the loss function of the first machine learning model based on the calculated difference between the parameters. For example, the loss function of the first machine learning model may be calculated based on a difference between the first class prediction data and the class label and the calculated difference between the parameters. For example, the difference between the first class prediction data and the class label may include a loss value (e.g., MSE, RMSE, and cross-entropy) based on the first class prediction data and the class label.

FIG. 4 illustrates an example of confidence calculation based on a reference loss and a prediction loss.

An electronic apparatus (e.g., the electronic apparatus 100 of FIG. 1) may calculate a confidence of a class label based on a reference loss 406 and a prediction loss 405.

The electronic apparatus may calculate a confidence 407 based on the reference loss 406 determined based on another training input (e.g., a training input different from the training input 401) and the calculated prediction loss 405. For example, the electronic apparatus may obtain class prediction data 403 by applying a first machine learning model 402 to the training input 401. The electronic apparatus may calculate the prediction loss 405 (e.g., a first prediction loss based on the first machine learning model) based on the class prediction data 403 and a class label 404. The electronic apparatus may calculate the confidence 407 of the class label 404 based on the prediction loss 405 and the reference loss 406. The electronic apparatus may perform training 408 of a second machine learning model based on the calculated confidence 407.

The reference loss 406 may be a loss used as a reference for the prediction loss 405. For example, when the prediction loss 405 is greater than the reference loss 406, a possibility that the class label 404 differs from a real class may be greater than a possibility that the class label is identical to the real class. When the prediction loss 405 is identical to the reference loss 406, the possibility that the class label 404 differs from the real class may be identical to the possibility that the class label is identical to the real class. When the prediction loss 405 is less than the reference loss 406, the possibility that the class label 404 differs from the real class may be less than the possibility that the class label is identical to the real class.

For example, it may be determined that the reference loss 406 is an average of prediction losses, wherein each of the prediction losses is calculated based on each of at least one other training input. When it is determined that the reference loss 406 is the average of prediction losses, the reference loss may be referred to as an average loss.

The electronic apparatus may calculate the confidence based on a difference between the prediction loss 405 and the reference loss 406. The electronic apparatus may perform the training 408 of the second machine learning model using the training input 401 based on the calculated confidence 407. For example, the electronic apparatus may calculate the difference between the prediction loss 405 and the reference loss 406 by subtracting the reference loss 406 from the prediction loss 405. The electronic apparatus may calculate the confidence 407 based on a value obtained by applying a sigmoid function to the difference between the prediction loss 405 and the reference loss 406. For example, the electronic apparatus may calculate the confidence 407 based on Equation 3 below, for example.

w=1−σ(Prediction Loss−Reference Loss) Equation 3:

Here, w may denote the confidence 407, Prediction Loss may denote the prediction loss 405 (e.g., the first prediction loss based on the first machine learning model), Reference Loss may denote the reference loss 406 (e.g., the average loss), and a may denote the sigmoid function.

The electronic apparatus may update the reference loss 406 based on the calculated prediction loss 405. For example, it may be determined that the reference loss 406 is the average of the prediction losses, wherein each of the prediction losses is calculated for each of the at least one other training input. The electronic apparatus may calculate an average of prediction losses of the at least one other training input and the training input 401. For example, the electronic apparatus may update summation of the prediction losses, wherein each of the prediction losses is calculated for each of the at least one other training input, by adding the prediction loss 405 to the summation and may update the average of the prediction losses by dividing the updated summation of the prediction losses by a number of training inputs (e.g., a number of at least one other training input plus one training input 401). The electronic apparatus may update the reference loss 406 to the updated average of the prediction losses.

The electronic apparatus may train the first machine learning model 402 based on the second machine learning model after the training 408 of the second machine learning model based on the training input 401. For example, the electronic apparatus may train the first machine learning model 402 by calculating the loss function of the first machine learning model 402 based on the second machine learning model and updating the parameter of the first machine learning model 402 based on the calculated loss function.

FIG. 5 illustrates an example of confidence calculation based on a first prediction loss and a second prediction loss.

An electronic apparatus (e.g., the electronic apparatus 100 of FIG. 1) may calculate a confidence 509 of a class label 504 based on a first prediction loss 505 and a second prediction loss 508. The electronic apparatus may train a second machine learning model 506 based on the calculated confidence 509. The calculation of the confidence 509 based on the first prediction loss 505 and the second prediction loss 508 is described below.

The electronic apparatus may calculate the first prediction loss 505 and the second prediction loss 508 based on first class prediction data 503 and second class prediction data 507 obtained by applying a first machine learning model 502 and a second machine learning model 506 to a training input 501. For example, the electronic apparatus may obtain the first class prediction data 503 by applying the first machine learning model 502 to the training input 501. The electronic apparatus may calculate the first prediction loss 505 based on the first class prediction data 503 and the class label 504. The electronic apparatus may obtain the second class prediction data 507 by applying the second machine learning model 506 to the training input 501. The electronic apparatus may calculate the second prediction loss 508 based on the second class prediction data 507 and the class label 504. The electronic apparatus may calculate the confidence 509 based on the first prediction loss 505 and the second prediction loss 508.

The electronic apparatus may calculate the confidence 509 based on a ratio of at least one of the first prediction loss 505 or the second prediction loss 508 to a sum of the first prediction loss 505 and the second prediction loss 508. For example, the electronic apparatus may calculate a ratio of the first prediction loss 505 to the sum of the first prediction loss 505 and the second prediction loss 508 as the confidence 509. The electronic apparatus may calculate the confidence 509 of the class label 504 with which the training input 501 is labeled such that the confidence 509 of the class label 504 decreases as the first prediction loss 505 of the training input 501 increases. The first prediction loss 505 may represent a difference between a class predicted based on the first machine learning model 502 and the class label 504. The electronic apparatus may use the second prediction loss 508 as a reference for the first prediction loss 505. The electronic apparatus may calculate the confidence 509 based on a magnitude of the first prediction loss 505 wherein the magnitude is relative to the second prediction loss 508. For example, the electronic apparatus may calculate the confidence 509 based on Equation 4 below, for example.

$$w = \frac{Prediction Loss\_ 2}{Prediction Loss\_ 1 + Prediction Loss\_ 2} \qquad Equation 4$$

Here, w may denote the confidence 509, Prediction Loss_1 may denote the first prediction loss 505, and Prediction Loss_2 may denote the second prediction loss 508.

After training the second machine learning model 506 based on the training input 501, the electronic apparatus may train the first machine learning model 502 based on the second machine learning model 506. For example, the electronic apparatus may train the first machine learning model 502 by calculating the loss function of the first machine learning model 502 based on the second machine learning model 506 and updating a parameter of the first machine learning model 502 based on the calculated loss function.

FIG. 6 illustrates an example of an operation of relabeling a training input with a class label.

An electronic apparatus (e.g., the electronic apparatus 100 of FIG. 1) may train a second machine learning model based on a confidence of a class label with which a training input is labeled. When the confidence is less than or equal to a threshold confidence, the electronic apparatus may relabel the training input with a class label and train the second machine learning model based on the class label with which the training input is relabeled.

In operation 610, the electronic apparatus may relabel the training input with the class label based on the calculated confidence being less than or equal to the threshold confidence.

The electronic apparatus may determine the threshold confidence based on a number of times the training input is relabeled. The electronic apparatus may relabel the training input when the calculated confidence is less than or equal to the determined threshold confidence.

For example, the electronic apparatus may determine the threshold confidence based on a threshold confidence mapped to each of a plurality of ranges of the number of times the training input is relabeled. For example, a threshold confidence (e.g., a first threshold confidence, a second threshold confidence, and a third threshold confidence) may be mapped to each of three ranges of the number of times the training input is relabeled. When the number of times the training input is relabeled is included in a first range (e.g., 0 or more and less than or equal to a first threshold number of times), the electronic apparatus may determine that the first threshold confidence mapped to the first range is the threshold confidence. When the number of times the training input is relabeled is included in a second range (e.g., more than the first threshold number of times and less than or equal to a second threshold number of times), the electronic apparatus may determine that the second threshold confidence mapped to the second range is the threshold confidence. When the number of times the training input is relabeled is included in a third range (e.g., more than the second threshold number of times), the electronic apparatus may determine that the third threshold confidence mapped to the third range is the threshold confidence. The second threshold confidence may be less than the first threshold confidence. The third threshold confidence may be less than the second threshold confidence. However, embodiments are not limited thereto, and a relationship in magnitude between the threshold confidences mapped to the ranges may vary depending on design.

The electronic apparatus may determine a performance criterion (e.g., the threshold confidence) for relabeling differently according to the number of times the training input has been already relabeled by determining the threshold confidence based on the number of times the training input is relabeled. For example, as the number of times the training input is relabeled increases, the threshold confidence may decrease or remain the same. The electronic apparatus may compare a class label that is already used to relabel the training input with a threshold confidence lower than a threshold confidence for a class label that is not used to relabel the training input. The electronic apparatus may relabel the training input with the class label that is already used to relabel the training input when a confidence lower than that of the class that is not used to relabel the training input is calculated.

The electronic apparatus may relabel the training input with a class based on a user input for relabeling the training input. For example, the electronic apparatus may obtain the user input to designate a class of the training input based on the confidence being less than or equal to the threshold confidence. A user input may include an input generated by an expert who selects a real class of a training input. For example, when the training input is an image of a semiconductor device (e.g., a wafer), the expert may generate a user input to designate a class (e.g., a normal class, a defective class, etc.) of the image based on the image. The electronic apparatus may relabel the training input with the class designated by the obtained user input.

The electronic apparatus may relabel the training input with the class based on the user input when the confidence is less than or equal to the threshold confidence, and thus, the expert may efficiently examine a class label with which a training dataset is labeled. In addition, the electronic apparatus may train the first machine learning model and/or the second machine learning model with the training dataset that reflects reexamination by the expert by relabeling the training input with a class based on the user input generated by the expert. The electronic apparatus may have a higher detection rate of label noise than an electronic apparatus according to a comparative embodiment. The detection rate of label noise may be a ratio of a number of noise occurrences to a number of class labels examined by the expert. The expert may examine a class label having a confidence less than or equal to the threshold confidence. When using the electronic apparatus according to an example, the expert examines a training input and a class label filtered based on a confidence of the class label, and accordingly, the detection rate of label noise may be higher than when the expert uses the electronic apparatus according to the comparative example.

The electronic apparatus may relabel the training input with a class based on the class prediction data obtained using the first machine learning model. The electronic apparatus may relabel the training input based on the class prediction data (e.g., first class prediction data) obtained by applying the first machine learning model to the training input. The electronic apparatus may relabel the training input with a class indicated by the first class prediction data based on the first machine learning model. For example, the electronic apparatus may relabel the training input with a class label having a maximum possibility score among a plurality of possibility scores of the first class prediction data.

The electronic apparatus may process label noise through relabeling without intervention of the expert by relabeling the training input with a class using the first class prediction data based on the first machine learning model.

In operation 620, the electronic apparatus may train a second machine learning model based on the training input and the class label with which the training input. The electronic apparatus may perform training of the second machine learning model based on the training input and the class label with which the training input is relabeled using the first machine learning model.

For example, the electronic apparatus may calculate a prediction loss based on the class prediction data (e.g., the first class prediction data) obtained by applying the first machine learning model to the training input and the class label with which the training input is relabeled. The electronic apparatus may calculate a confidence of the class label with which the training input is relabeled based on the calculated prediction loss. The electronic apparatus may train the second machine learning model using the training input based on the confidence of the class label with which the training input is relabeled. All or some operations of any one or any combination of any two or more of the calculation of the prediction loss, the calculation of the confidence, and the training of the second machine learning model may be performed based on the operations described with reference to FIGS. 1 to 6.

The electronic apparatuses, processors, memories, communicators, electronic apparatus 100, processor 110, memory 120, communicator 130, electronic apparatus 200a, processor 210a, memory 220a, communicator 230a, electronic apparatus 200b, processor 210b, memory 220b, communicator 230b, and other apparatuses, devices, and components described and disclosed herein with respect to FIGS. 1-6 are implemented by or representative of hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-6 that perform the operations described in this application are performed by computing hardware, for example, by one or more processors or computers, implemented as described above implementing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media. Examples of a non-transitory computer-readable storage medium include read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. A processor-implemented method, the method comprising:
determining a prediction loss based on class prediction data obtained by applying a first machine learning model to a training input and a class label with which the training input is labeled;
determining a confidence of the class label based on the determined prediction loss; and
training a second machine learning model using the training input based on the determined confidence.

2. The method of claim 1, wherein the first machine learning model is trained using a symmetric loss function used to determine a sum of values of the symmetric loss function as a constant, in which the values are determined in response to a prediction that a training input is classified as each of a plurality of classes.

3. The method of claim 1, wherein the determining of the confidence comprises determining a confidence that represents a probability that the class label is identical to a real class of the training input.

4. The method of claim 1, wherein the determining of the confidence comprises:
determining the confidence based on a reference loss determined based on another training input and the determined prediction loss; and
updating the reference loss based on the determined prediction loss.

5. The method of claim 1, wherein
the determining of the prediction loss comprises:
determining a first prediction loss based on first class prediction data obtained by applying the first machine learning model and the class label; and
determining a second prediction loss based on second class prediction data obtained by applying the second machine learning model to the training input and the class label, and
the determining of the confidence comprises determining the confidence based on the determined first prediction loss and the determined second prediction loss.

6. The method of claim 1, wherein the training of the second machine learning model comprises updating a parameter of the second machine learning model using second class prediction data obtained by applying the second machine learning model to the training input, the class label, and a loss function of the second machine learning model determined based on the determined confidence.

7. The method of claim 1, wherein the training of the second machine learning model further comprises updating a parameter of the second machine learning model using a loss function of the second machine learning model from which a symmetric loss function is excluded.

8. The method of claim 1, further comprising updating a parameter of the first machine learning model using a loss function of the first machine learning model determined based on a difference between parameters of the first machine learning model and the second machine learning model.

9. The method of claim 1, wherein the training of the second machine learning model comprises:
relabeling the training input with a class label based on the determined confidence being less than or equal to a threshold confidence; and
training the second machine learning model based on the training input and the class label with which the training input is relabeled.

10. The method of claim 9, wherein the relabeling of the training input with the class label comprises relabeling the training input with the class label based on a user input for relabeling the training input.

11. The method of claim 9, wherein the relabeling of the training input with the class label comprises:
determining a threshold confidence based on a number of times the training input is relabeled; and
relabeling the training input with the class label in response to the determined confidence being less than or equal to the determined threshold confidence.

12. The method of claim 9, wherein the relabeling of the training input with the class label comprises relabeling the training input based on the class prediction data obtained using the first machine learning model.

13. A non-transitory computer-readable storage medium storing instructions that, when executed by one or more processors, configure the one or more processors to perform the method of claim 1.

14. An electronic apparatus comprising:
one or more processors configured to:
determine a prediction loss based on class prediction data obtained by applying a first machine learning model to a training input and a class label with which the training input is labeled;
determine a confidence of the class label based on the determined prediction loss; and
train a second machine learning model using the training input based on the determined confidence.

15. The electronic apparatus of claim 14, wherein the first machine learning model is trained using a symmetric loss function used to determine a sum of values of the symmetric loss function as a constant, in which the values are determined in response to prediction that a training input is classified as each of a plurality of classes.

16. The electronic apparatus of claim 14, wherein, for the determining of the confidence, the one or more processors are configured to determine a confidence that represents a probability that the class label is identical to a real class of the training input.

17. The electronic apparatus of claim 14, wherein, for the determining of the confidence, the one or more processors are configured to:
determine the confidence based on a reference loss determined based on another training input and the determined prediction loss; and
update the reference loss based on the determined prediction loss.

18. The electronic apparatus of claim 14, wherein the one or more processors are configured to:
for the determining of the prediction loss,
determine a first prediction loss based on first class prediction data obtained by applying the first machine learning model and the class label; and
determine a second prediction loss based on second class prediction data obtained by applying the second machine learning model to the training input and the class label; and
for the determining of the confidence, determine the confidence based on the determined first prediction loss and the determined second prediction loss.

19. The electronic apparatus of claim 14, wherein the one or more processors are configured to update a parameter of the second machine learning model using a loss function of the second machine learning model from which a symmetric loss function is excluded.

20. The electronic apparatus of claim 14, wherein the one or more processors are configured to:
relabel the training input with a class label based on the determined confidence being less than or equal to a threshold confidence; and
train the second machine learning model based on the training input and the class label with which the training input is relabeled.

21. A processor-implemented method, the method comprising:
determining class prediction data by applying a trained second machine learning model to input data; and
classifying the input data based on the determined class prediction data,
wherein the second machine learning model is trained by determining a prediction loss based on training class prediction data obtained by applying a first machine learning model to a training input and a class label with which the training input is labeled.
